(19) United States
(12) Patent Application Publication
(10) Pub. No.: US 2024/0082954 A1
(43) Pub. Date: Mar. 14, 2024

(54) BIPOLAR PLATE FOR A FUEL CELL AND PROCESS FOR WELDING A BIPOLAR PLATE

(71) Applicant: TRUMPF Laser- und Systemtechnik GmbH, Ditzingen (DE)

(72) Inventor: Oliver Bocksrocker, Sachsenheim (DE)

(21) Appl. No.: 18/517,100

(22) Filed: Nov. 22, 2023

Related U.S. Application Data
(63) Continuation of application No. PCT/EP2022/063465, filed on May 18, 2022.

(30) Foreign Application Priority Data
May 28, 2021 (DE) 102021113834.5

(51) Int. Cl. B23K 26/244; B23K 26/073; B23K 26/082; H01M 8/021; H01M 8/0247; H01S 3/067; H01S 3/102

(52) U.S. Cl. CPC B23K 26/244; B23K 26/0734; B23K 26/082; H01M 8/021; H01M 8/0247; H01S 3/06791; H01S 3/102; B23K 2103/05

(57) ABSTRACT

A method for laser welding of a bipolar plate for a fuel cell is provided. The bipolar plate includes two metallic plate parts. The method includes producing at least one continuously enclosing first weld seam with a first seam width, and producing at least one second weld seam with a second seam width. The second seam width is at least 10% greater than the first seam width.

### CROSS REFERENCE TO RELATED APPLICATIONS

This application is a continuation of International Application No. PCT/EP2022/063465 (WO 2022/248312 A1), filed on May 18, 2022, and claims benefit to German Patent Application No. DE 10 2021 113 834.5, filed on May 18, 2021. The aforementioned applications are hereby incorporated by reference herein.

### FIELD

Embodiments of the present invention relate to a process for welding a bipolar plate for a fuel cell including two metallic plate parts. Embodiments of the present invention also relate to a bipolar plate for a fuel cell, wherein the bipolar plate has two plate parts welded to each other.

### BACKGROUND

Bipolar plates are used in fuel cells with multiple cells arranged in layers to form a stack for the distribution of gases, in particular hydrogen or oxygen, the removal of water, gas-tight separation between adjacent cells and also sealing with respect to the outside and cooling. In addition, the bipolar plate on the hydrogen side absorbs the emitted electrons and feeds them back to the oxygen side.

Such bipolar plates may have two metallic plate parts which are welded to each other. On the one hand, weld seams involved here need to be made fluid-tight in order to direct gases or water in defined paths. On the other hand, weld seams are used for the electrical and mechanical connection of the two plate parts.

### SUMMARY

Embodiments of the present invention provide a method for laser welding of a bipolar plate for a fuel cell. The bipolar plate includes two metallic plate parts. The method includes producing at least one continuously enclosing first weld seam with a first seam width, and producing at least one second weld seam with a second seam width. The second seam width is at least 10% greater than the first seam width.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a bipolar plate according to embodiments of the invention with two plate parts, which are connected to each other by three first continuously enclosing weld seams and multiple second weld seams which extend here in a straight line, in a schematic plan view;

FIG. 2 shows a bipolar plate with two plate parts in the laser welding of a first weld seam with a first seam width according to some embodiments, wherein an active laser fibre of a laser light source is in a first state of stress, so that a thin laser beam is emitted in a first laser mode, in a schematic sectional view;

FIG. 3 shows the bipolar plate from FIG. 2 in the laser welding of a second weld seam with a second seam width according to some embodiments, wherein the active laser fibre is in a second state of stress, so that a thicker laser beam is emitted in a second laser mode, in a schematic sectional view;

FIG. 4 shows a bipolar plate with two plate parts in the laser welding of a first weld seam with a first seam width according to some embodiments, wherein a thin laser beam is emitted from a core fibre of a laser fibre, in a schematic sectional view;

FIG. 5 shows the bipolar plate from FIG. 4 in the welding of a second weld seam with a second seam width according to some embodiments, wherein a thicker laser beam is emitted from a ring fibre surrounding the core fibre of the laser fibre, in a schematic sectional view;

FIG. 6 shows a bipolar plate in the welding of two plate parts according to some embodiments, wherein a laser beam is emitted from a laser light source with a zoom optics, in a schematic sectional view;

FIG. 7 shows a bipolar plate in the welding of two plate parts according to some embodiments, wherein a distance of a processing head of a laser light source from the bipolar plate is variable in order to set a focal position of a laser beam relative to the bipolar plate, in a schematic sectional view; and

FIG. 8 shows a bipolar plate in the welding of two plate parts according to some embodiments, wherein a laser beam is emitted from a laser light source with a scanner optics, in a schematic sectional view.

### DETAILED DESCRIPTION

Embodiments of the invention can improve the cost-effectiveness of the production of bipolar plates and at the same time the properties of these bipolar plates.

According to embodiments of the invention, a process for laser welding a bipolar plate for a fuel cell is provided. The bipolar plate is formed from two metallic plate parts which are connected to each other by laser welding. The two plate parts always overlap each other over a flat surface area. The weld seams produced in the course of the process connect the two plate parts to each other. The plate parts welded to each other form the bipolar plate. The process according to embodiments of the invention allows the production of a bipolar plate according to embodiments of the invention described below.

When welding the two plate parts, at least one continuously enclosing first weld seam with a first seam width is produced. The continuously enclosing first weld seam is gas-tight. The continuously enclosing first weld seam or each of the continuously enclosing first weld seams closes off an inner area between the two plate parts gas-tightly with respect to the outside.

In addition, at least one second weld seam with a second seam width is created when welding the two plate parts. The at least one second weld seam is usually not continuously enclosing; in other words, it typically has two end points. The at least one second weld seam is used in particular for the mechanically stable connection of the two plate parts. Furthermore, the at least one second weld seam can create a connection of the two plate parts with a low electrical resistance.

According to embodiments of the invention, the second seam width is greater than the first seam width, in particular by at least 10%. The second seam width may be at least 20% greater than the first seam width. Typically, the first weld seam is a maximum of twice as wide as the second weld seam, in particular a maximum of 50% wider. Due to the different seam widths, the weld seams are optimized to suit their respective requirements. A narrow weld seam is sufficient for a fluid-tight connection. This also reduces the heat input when creating the first weld seam. In addition, a narrow weld seam can be created more quickly and therefore more cost-effectively. In contrast, the greater width of the at least one second weld seam improves the electrical conductivity and strength.

The first seam width may be at least 20 μm, preferably at least 60 μm, and/or at most 200 μm, preferably at most 80 μm. The second seam width may be at least 22 μm, preferably at least 30 μm, preferably at least 66 μm, and/or at most 600 μm, preferably at most 180 μm. It goes without saying that the seam widths are always chosen within the specified ranges such that the second seam width is greater than the first seam width. The seam widths are usually constant for the respective weld seams over their respective length.

A feed rate (in the direction of the weld seams to be created) may be at least 100 mm/s, preferably at least 300 mm/s, and/or at most 3000 mm/s, preferably at most 1000 mm/s. Preferably, the feed rate for the first weld seam is greater than for the second weld seam, in particular by at least 10%. The feed rate for the first weld seam may be at least 20% greater than for the second weld seam. Typically, the feed rate for the first weld seam is a maximum of twice as great as for the second weld seam, in particular a maximum of 50% greater. Since enclosing weld seams are typically relatively long, the greater feed rate increases the cost-effectiveness of the production process. Typically, the second weld seam is comparatively short or the total length of the plurality of second weld seams is typically much shorter than the total length of the first weld seam or weld seams. The lower feed rate when creating the at least one second weld seam therefore does not significantly affect the production time, but significantly improves the properties of the bipolar plate.

The beam parameter product of a laser beam used for welding the two weld seams may be at least 0.38 mm*mrad and/or at most 16 mm*mrad, preferably at most 4 mm*mrad, preferably at most 1 mm*mrad. In particular, the beam parameter product may be 0.4 mm*mrad.

An infrared laser may be used for the welding. The laser beam used for the welding may have a wavelength of at least 800 nm, preferably at least 900 nm, and/or at most 1200 nm, preferably at most 1100 nm. In particular, the wavelength may be 1070 nm.

A laser power of the laser beam used for the welding may be at least 100 W, preferably at least 300 W and/or at most 2000 W, preferably at most 500 W.

The two plate parts may be made of preferably stainless high-grade steel, in particular austenitic high-grade steel. The high-grade steel may be X2CrNiMo17-12-2 (material number 1.4404, AISI 316L).

A thickness of at least one of the plate parts, preferably both plate parts, may be at least 50 μm, preferably at least 70 μm, and/or at most 150 μm, preferably at most 100 μm. In particular, the thickness may be 75 μm. Typically, the two plate parts are equally thick.

A laser beam used for the welding may have a first beam diameter at the point of impact on the bipolar plate when welding the first weld seam and a second beam diameter when welding the second weld seam. The second beam diameter is greater than the first beam diameter, preferably by at least 10%. The second beam diameter may be at least 20% greater than the first beam diameter. Typically, the first beam diameter is a maximum of twice as great as the second beam diameter, in particular a maximum of 50% greater. In this way, it can be achieved in an easy way that the second seam width is greater than the first seam width.

The first beam diameter may be at least 10 μm, preferably at least 30 μm, and/or at most 200 μm, preferably at most 50 μm. The second beam diameter may be at least 11 μm, preferably at least 33 μm, and/or at most 300 μm, preferably at most 90 μm. It goes without saying that the beam diameters are always chosen within the specified ranges such that the second beam diameter is greater than the first beam diameter.

The laser beam may be emitted from a laser light source which has an active laser fibre, the mode field of which can be changed by introducing mechanical stress. A first state of stress of the laser fibre is set up for welding the first weld seam and a second state of stress of the laser fibre is set up for welding the second weld seam, so that the first weld seam and the second weld seam are welded with different laser modes. In the first state of stress, the laser beam may have a Gaussian or top-hat-like intensity profile. In the second state of stress, the laser beam may have a ring-shaped, preferably circular, intensity profile. In other words, a ring mode may be active in the second state of stress. By manipulating the mechanical state of stress of the active laser fibre, it is possible to switch between the different laser modes and thus beam diameters quickly.

Alternatively, the laser beam may be emitted from a laser light source which has a laser fibre with a core fibre and a ring fibre. The ring fibre surrounds the core fibre. The laser beam is emitted from the core fibre for welding the first weld seam and emitted from the ring fibre for welding the second weld seam. Such laser light sources have proven themselves in laser welding and allow quick switching over of the beam diameter.

The laser light source has at least one laser module for generating laser light. In particular, the laser light source may have a single laser module. Alternatively, the laser light source may have multiple, preferably two, laser modules. A separate laser module can be provided each for the core fibre and the ring fibre. The laser beam emitted from the core fibre for welding the first weld seam can thus be generated by a different laser module than the laser beam emitted from the ring fibre for welding the second weld seam. This allows an advantageous adaptation of the properties of the laser beam for welding the first or second weld seam.

The laser beam may have a central intensity maximum in the interior of its cross section when welding the first weld seam and a ring-shaped, preferably circular, intensity maximum outside its centre when welding the second weld seam. In other words, when welding the first weld seam, the intensity of the laser beam decreases from the centre radially to the outside. When welding the second weld seam, the intensity of the laser beam is less in its centre than in the region of the ring-shaped intensity maximum lying radially outside the centre; in particular, the intensity in the centre may be zero. These intensity profiles support the desired properties of the first and second weld seams.

The laser beam may be emitted from a laser light source which has a zoom optics, which preferably allows an imaging ratio of between 1:1 and 5:1. A first zoom factor of the zoom optics is applied for welding the first weld seam and a second zoom factor of the zoom optics is applied for welding the second weld seam, wherein the second zoom factor is greater than the first zoom factor, preferably by at least 10%. The zoom optics make it easy to upgrade an existing laser light source. In addition, many different beam diameters can be produced by means of the zoom optics, so that the optimum beam diameter can be chosen for the respective application.

The focal positions of the laser beam may differ from each other when welding the first weld seam and the second weld seam. Preferably, for this purpose a processing head of a laser light source is moved in the radiating direction of the laser beam to different distances from the bipolar plate. This allows the use of an existing machine axis of a laser welding machine for changing the seam width. The focal position refers to the position of the focal point of the laser beam relative to the surface of the plate part which the laser beam hits.

A laser beam used for the welding may be emitted from a laser light source which has a scanner optics. When welding the second weld seam, the laser beam is deflected in an oscillating manner transversely to a feed direction. The scanner optics allows a high degree of flexibility in the welding process and, in particular, a quick change between different seam widths. In this variant, the welding of the first and second weld seams usually takes place with the same beam diameter. Apart from the feed rate, other parameters of the welding process are also typically chosen identically for the welding of the first and second weld seams.

An amplitude of the oscillation movement of the laser beam when welding the second weld seam may be at least 5%, preferably at least 10%, of a beam diameter of the laser beam at the point of impact on the bipolar plate.

Typically, the laser beam is not deflected in an oscillating manner transversely to the feed direction when welding the first weld seam. An amplitude of the oscillation movement when welding the second weld seam is then typically at least 5% of the first seam width of the first weld seam. However, it may be provided that the laser beam is deflected in an oscillating manner transversely to the feed direction when welding the first weld seam; an amplitude of the oscillation movement when welding the second weld seam is then greater than when welding the first weld seam, preferably by at least 10%.

The scanner optics may have a imaging ratio of at least 1.1:1, preferably at least 1.5:1, and/or at most 5:1, preferably at most 1.7:1. The imaging ratio indicates the magnification of the beam diameter by the scanner optics. The imaging ratio m can be calculated from the ratio of the focal length f of a lens and a collimation focal length fc as m=f/fc.

Embodiments of the present invention provide a bipolar plate for a fuel cell. The bipolar plate has two plate parts welded to each other.

At least one continuously enclosing, first weld seam between the two plate parts has a first seam width. The continuously enclosing first weld seam is always gas-tight. In particular, the continuously enclosing first weld seam or each of the continuously enclosing first weld seams closes off an interior area between the two plate parts gas-tightly with respect to the outside.

At least one second weld seam between the two plate parts has a second seam width. The at least one second weld seam is usually not continuously enclosing; in other words, it typically has two end points. The at least one second weld seam is used in particular for the mechanically stable connection of the two plate parts. Furthermore, the at least one second weld seam can create a connection of the two plate parts with a low electrical resistance.

Typically, the first weld seam surrounds the at least one second weld seam.

In special cases, the second weld seam may also be continuously enclosing. The second weld seam may at least partially surround the first weld seam.

According to embodiments of the invention, the second seam width is greater than the first seam width, preferably by at least 10%. The second seam width may be at least 20% greater than the first seam width. Typically, the first weld seam is a maximum of twice as wide as the second weld seam, in particular a maximum of 50% wider. Due to the different seam widths, the weld seams are optimized to suit their respective requirements. A narrow weld seam is sufficient for a fluid-tight connection. This also reduces the heat input when creating the first weld seam. In contrast, the greater width of the at least one second weld seam improves the electrical conductivity and strength.

The first seam width may be at least 20 μm, preferably at least 60 μm, and/or at most 200 μm, preferably at most 80 μm. The second seam width may be at least 22 μm, preferably at least 30 μm, preferably at least 100 μm, and/or at most 600 μm, preferably at most 180 μm. It goes without saying that the seam widths are always chosen within the specified ranges such that the second seam width is greater than the first seam width.

The two plate parts may be made of preferably stainless high-grade steel, in particular austenitic high-grade steel. The high-grade steel may be X2CrNiMo17-12-2 (material number 1.4404, AISI 316L).

A thickness of at least one of the plate parts, preferably both plate parts, is at least 50 μm, preferably at least 70 μm, and/or at most 150 μm, preferably at most 100 μm. In particular, the thickness may be 75 μm. Typically, the two plate parts are equally thick.

The use of a bipolar plate according to embodiments of the invention described above in a fuel cell is also within the scope of the present invention. Furthermore, a fuel cell with a bipolar plate according to embodiments of the invention as described above is within the scope of the present invention.

Further advantages of the embodiments of the invention are evident from the claims, the description and the drawing. According to embodiments of the invention, the features mentioned above and those still to be further presented can be used in each case individually or together in any desired expedient combinations. The embodiments shown and described should not be understood as an exhaustive enumeration, but rather are of exemplary character for outlining the invention

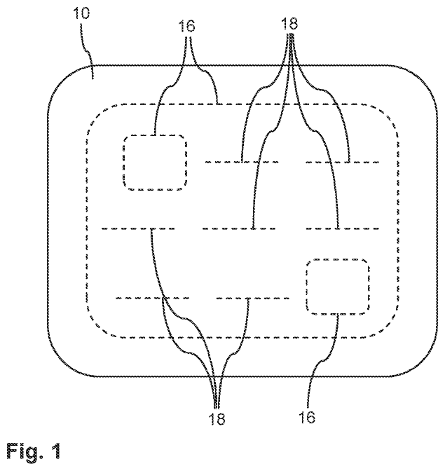

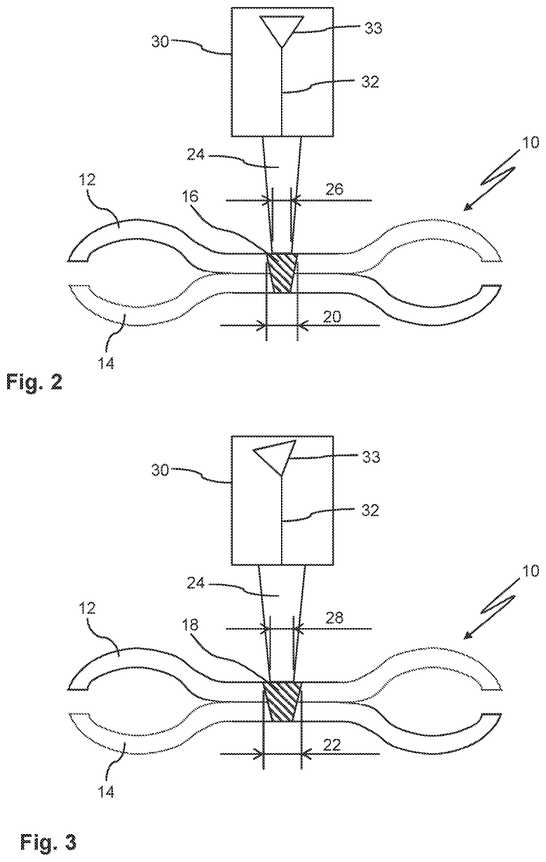

FIG. 1 shows a bipolar plate 10 for a fuel cell not shown in any more detail. The bipolar plate 10 has two plate parts 12, 14 overlapping each other and welded to each other over a flat surface area, compare FIGS. 2 to 8. The two plate parts 12, 14 may consist of stainless, austenitic high-grade steel. A thickness of the two plate parts 12, 14 may be for example 75 μm.

The two plate parts 12 and 14 are in each case connected to each other by multiple first weld seams 16 and second weld seams 18. The first weld seams 16 are formed as continuously enclosing. The first weld seams 16 may include for example fluid-carrying channels or areas. The first weld seams 16 are always fluid-tight.

The second weld seams 18 each have two end points here; in other words they are not continuously enclosing. In the present case, a linear course of the second weld seams 18 is shown by way of example. It goes without saying that at least some of the second weld seams could be curved. The second weld seams 18 are used for the mechanical and electrically conductive connection of the two plate parts 12, 14.

As can be seen for example in FIGS. 2 and 3, a first seam width 20 of the first weld seams 16 is smaller than a second seam width 22 of the second weld seams 18. The second seam width 22 may be for example 10% to 20%, here about 15%, greater than the first seam width 20. The first seam width 20 may be for example about 30 μm; correspondingly, the second seam width 22 may be for example about 35 μm. The first and second seam widths 20, 22 may each designate a greatest width of the respective weld seams 16, 18.

The first and second weld seams 16, 18 are created by a laser welding process. In the exemplary embodiment shown in FIGS. 2 and 3, a laser beam 24 is emitted from a laser light source 30, which has an active laser fibre 32 with a mode field which can be changed by mechanical stressing.

For welding the first weld seams 16, a first state of stress of the active laser fibre 32 is set up (indicated in FIG. 2 by the position of an actuator 33). The laser light source 30 thus operates in a first laser mode. The laser beam 24 may in this case obtain a central maximum intensity in the interior of its cross section. At the point of impact on the plate part 12, the laser beam 24 has a first beam diameter 26. The first beam diameter 26 is typically slightly smaller than the first seam width 20.

For welding the second weld seams 18, a second state of stress of the active laser fibre 32 is set up (indicated in FIG. 3 by the position of the actuator 33 changed from FIG. 2). The laser light source 30 thus operates in a second laser mode. The laser beam 24 may in this case obtain a ring-shaped intensity maximum, wherein the intensity of the laser radiation decreases to the centre of the laser beam 24, in particular to zero. At the point of impact on the plate part 12, the laser beam 24 has a second beam diameter 28. The second beam diameter 28 is typically slightly smaller than the second seam width 22.

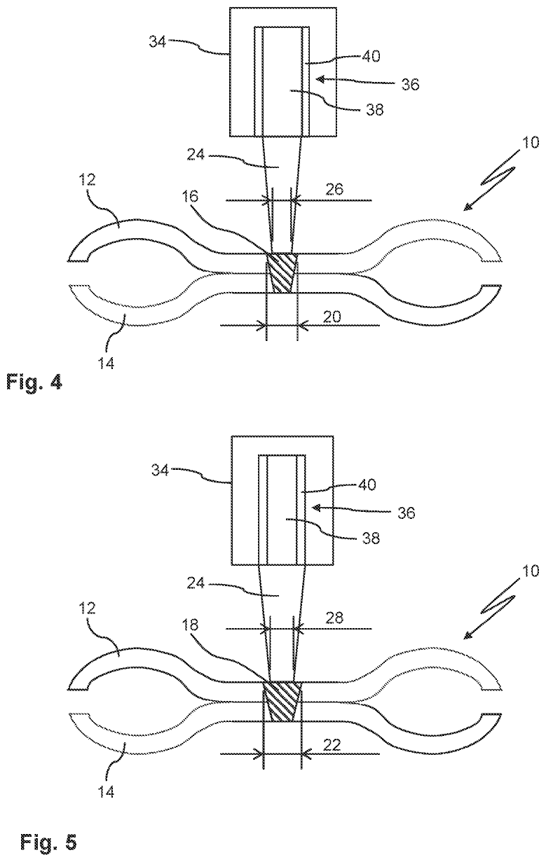

In the exemplary embodiment of FIGS. 4 and 5, a laser beam 24 is emitted from a laser light source 34, wherein a laser fibre 36 has a core fibre 38 and a ring fibre 40 surrounding the core fibre 38. To create the first weld seams 16, the laser beam 24 exits from the core fibre 38, so that it has a first beam diameter 26 at the point of impact on the plate part 12. The laser beam 24 may in this case have a Gaussian intensity profile. To create the second weld seams 18, the laser beam 24 exits from the ring fibre 40, so that it has a second beam diameter 28 at the point of impact on the plate part 12. The laser beam 24 may in this case have an intensity profile with a central intensity minimum and a ring-shaped intensity maximum.

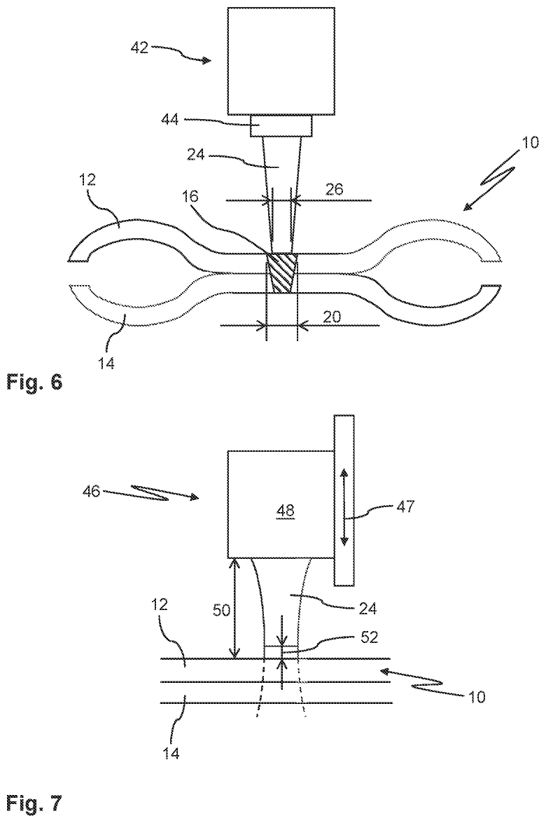

According to FIG. 6, a laser light source 42 with a zoom optics 44 may be used for the emission of a laser beam 24 for welding the plate parts 12, 14. FIG. 6 shows the creation of a first weld seam 16. In this case, a first zoom factor of the zoom optics 44 is set, so that the laser beam 24 has a first beam diameter 26 at the point of impact on the plate part 12. To create a second weld seam 18 (compare FIG. 1), a second zoom factor which is greater than the first zoom factor is correspondingly set, so that the laser beam 24 has at the point of impact on the plate part 12 a second beam diameter which is greater than the first beam diameter 26. This ensures that the second weld seam 18 is wider than the first weld seam 16.

As shown in FIG. 7, a laser light source 46 with a processing head 48 which can be moved along a machine axis 47 may be used for welding the two plate parts 12, 14. To create the first or second weld seams 16, 18, the processing head 48 is moved to different distances 50from the bipolar plate 10. Thus, a focal position 52 of a laser beam 24 changes relative to the bipolar plate 10. To create the first weld seam 16, the focal point of the laser beam 24 may lie close to the surface of the plate part 12 facing the processing head 48. To create the second weld seam 18, the focal point of the laser beam 24 may be moved further away from the surface of the plate part 12 facing the processing head 48, for example away from the bipolar plate 10 or alternatively into the bipolar plate 10 in the direction of the second plate part 14.

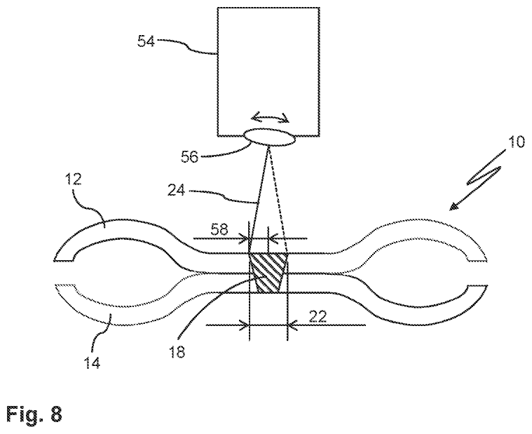

FIG. 8 shows that a laser light source 54 with a scanner optics 56 may be used for welding the plate parts 12, 14 of the bipolar plate 10. The scanner optics 56 makes it possible to deflect a laser beam 24 in an oscillating manner transversely to a feed direction (along the weld seam to be created). To create a wider second weld seam 18, an amplitude 58 of the oscillation movement of the laser beam 24 which is greater than when creating the narrower first weld seam 16 is set by means of the scanner optics 56. In particular, the first weld seam 16 may be welded without an oscillation movement. The amplitude 58 in the welding of the second weld seam 18 may be for example 12% of a beam diameter of the laser beam 24 at the point of impact on the plate part 12.

Thus, embodiments of the invention relate to a laser welding process for producing a bipolar plate for a fuel cell from two metallic plate parts. At least one first weld seam is formed as continuously enclosing in order to seal off areas between the plate parts with respect to an environment. At least one second weld seam is wider than the first weld seam. The second weld seam can improve the stability of the bipolar plate. Furthermore, the second weld seam can create a connection of the two plate parts with a low electrical resistance. The narrower first weld seam can be created at a greater feed rate than the wider second weld seam. This allows efficient production with at the same time improved properties of the bipolar plate.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

Bipolar plate 10
Plate parts 12, 14
First weld seams 16
Second weld seams 18
First seam width 20
Second seam width 22
Laser beam 24
First beam diameter 26
Second beam diameter 28
Laser light source 30
Active laser fibre 32
Actuator 33
Laser light source 34
Laser fibre 36
Core fibre 38
Ring fibre 40
Laser light source 42
Zoom optics 44
Laser light source 46
Machine axis 47
Processing head 48
Distances 50
Focal position 52
Laser light source 54
Scanner optics 56
Amplitude 58

1. A method for laser welding of a bipolar plate for a fuel cell comprising two metallic plate parts, the method comprising:
producing at least one continuously enclosing first weld seam with a first seam width, and
producing at least one second weld seam with a second seam width,
wherein the second seam width is at least 10% greater than the first seam width.

2. The method according to claim 1, wherein the first seam width is at least 20 μm, and/or at most 200 μm.

3. The method according claim 1, wherein the second seam width is at least 22 μm, and/or at most 600 μm.

4. The method according to claim 1, wherein a laser beam used for the production of the at least one first weld seam and the at least one second weld seam has a first beam diameter at a point of impact on the bipolar plate when producing the first weld seam and a second beam diameter when producing the second weld seam, wherein the second beam diameter is at least 10% greater than the first beam diameter.

5. The method according to claim 4, wherein
the laser beam is emitted from a laser light source that comprises an active laser fibre, wherein a mode field of the active laser fibre is capable of being changed by introducing a mechanical stress to the active laser fibre,
and a first state of the stress of the laser fibre is set up for producing the first weld seam and a second state of the stress of the laser fibre is set up for producing the second weld seam, so that the first weld seam and the second weld seam are produced with different laser modes.

6. The method according to claim 4, wherein the laser beam is emitted from a laser light source that comprises a laser fibre with a core fibre and a ring fibre,
and wherein the laser beam is emitted from the core fibre for producing the first weld seam, and is emitted from the ring fibre for producing the second weld seam.

7. The method according to claim 4, wherein the laser beam has a central intensity maximum in an interior of a cross section when producing the first weld seam, and has a ring-shaped intensity maximum outside a center when producing the second weld seam.

8. The method according to claim 4, wherein the laser beam is emitted from a laser light source that comprises a zoom optics, which allows an imaging ratio of between 1:1 and 5:1,
and wherein a first zoom factor of the zoom optics is applied for producing the first weld seam, and a second zoom factor of the zoom optics is applied for producing the second weld seam, wherein the second zoom factor is at least 10% greater than the first zoom factor.

9. The method according to claim 4, wherein focal positions of the laser beam differ from each other when producing the first weld seam and the second weld seam.

10. The method according to claim 9, wherein the laser beam is emitted from a laser source, and a processing head of the laser source is moved in a radiating direction of the laser beam to different distances from the bipolar plate when producing the first weld seam and the second weld seam.

11. The method according to claim 1, wherein
a laser beam used for the producing the first weld seam and the second weld seam is emitted from a laser light source that comprises a scanner optics,
and wherein, when producing the second weld seam, the laser beam is deflected in an oscillation movement transversely to a feed direction.

12. The method according to claim 11, wherein an amplitude of the oscillation movement of the laser beam when producing the second weld seam is at least 5% of a beam diameter of the laser beam at a point of impact on the bipolar plate.

13. The method according to claim 11, wherein the scanner optics has an imaging ratio of at least 1.1:1, and/or at most 5:1.

14. A bipolar plate for a fuel cell, comprising two plate parts welded to each other,
wherein at least one continuously enclosing first weld seam between the two plate parts has a first seam width,
wherein at least one second weld seam between the two plate parts has a second seam width,
and wherein the second seam width is at least 10% greater than the first seam width.

15. The bipolar plate according to claim 14, wherein the two plate parts comprise stainless high-grade steel.

16. The bipolar plate according to claim 14, wherein a thickness of at least one of the two plate parts is at least 50 μm, and/or at most 150 μm.
